(19) United States
(12) Patent Application Publication
(10) Pub. No.: US 2021/0174317 A1
(43) Pub. Date: Jun. 10, 2021

(54) METHOD AND SYSTEM FOR MODIFIED MINING PROBABILITIES BASED ON FEES

(71) Applicant: MASTERCARD INTERNATIONAL INCORPORATED, Purchase, NY (US)

(72) Inventors: Chandan GARG, Gurgaon (IN); Ankur ARORA, New Delhi (IN); Aditya KODURI, Gurgaon (IN); Jaipal Singh KUMAWAT, Sikar (IN)

(73) Assignee: MASTERCARD INTERNATIONAL INCORPORATED, Purchase, NY (US)

(21) Appl. No.: 16/705,339

(22) Filed: Dec. 6, 2019

(51) Int. Cl. G06Q 20/06; H04L 9/06; H04L 9/08

(52) U.S. Cl. CPC G06Q 20/065; H04L 9/0637; H04L 2209/56; H04L 2209/38; H04L 9/0861

(57) ABSTRACT

A method for awarding blocks in a blockchain for mining based on fee reimbursement to encourage reduction in mining fees includes: receiving a plurality of mining bids, where each mining bid is submitted by a blockchain node in a blockchain network and includes a fee reduction amount; selecting a winning bid of the plurality of mining bids based on the fee reduction amount included in each of the plurality of mining bids; transmitting a notification message to a winning blockchain node that submitted the winning bid; receiving a completed block including a block header and a plurality of data values, wherein the plurality of data values includes a mining data value that includes a destination address associated with the winning blockchain node and a mining fee amount; and verifying the mining fee amount based on at least the fee reduction amount included in the selected winning bid.

### FIELD

The present disclosure relates to awarding blocks in a blockchain for mining based on fee reimbursements to encourage reduction in mining fees, specifically collecting bids from miners that will reduce mining fees and selecting the winning miner from the pool of bids to reduce mining fees paid by participants and encourage miners.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. Blockchains often rely on miners that participate in confirming transactions, where miners generally operate on the collection of fees. Traditionally, miners tend to more quickly confirm transactions that pay higher fees as it is in their financial interest to do so, which can be detrimental for participants that are unable or unwilling to pay large fees, such as individuals and small businesses that may be unable to compete with large merchants and organizations.

Currently, blockchain nodes that mine new blocks have no incentive to confirm and include transactions with low mining fees. As a result, a transaction that is submitted would pay a low fee for the service may wait in a queue for hours for confirmation, which can be frustrating, harmful for a small business, and have considerable negative effects for the participant. Thus, there is a need for a technical system that encourages reduced fees and incentivizes miners to confirm transactions regardless of fee amount.

### SUMMARY

The present disclosure provides a description of systems and methods for awarding blocks in a blockchain for mining based on fee reimbursement to encourage reduction in mining fees. Each miner interested in mining blocks in a blockchain must submit a bid, where the bid includes a pledge by the miner to reduce mining fees accepted by them in terms of a percentage or flat amount (e.g., to collect only 60% of mining fees, to return 5 units of currency worth of fees for each transaction, etc.). A processor in the blockchain may collect all of the bids and select one of the bids as a winning bid, where the selection may be random, and may also be weighted based on the bids such that a greater reduction in fees may afford the node with a higher chance to be selected. The winning bid that is selected enables the associated node to mine the next block or number of blocks and collect the fees therefrom, reduced based on their bid. The result is that nodes are encouraged to reduce the fees they collect, as their ability to continue to mine blocks, and thus collect revenue, would be decreased if they were unwilling to reduce their collected fees. This will, in turn, benefit participants that can submit transactions and enjoy reduced fees. The present disclosure explains one way for carrying out this incentive plan on a computer system that is more efficient than others.

A method for awarding blocks in a blockchain for mining based on fee reimbursement to encourage reduction in mining fees includes: receiving, by a receiver of a processing server, a plurality of mining bids, where each mining bid is submitted by a blockchain node in a blockchain network and includes at least a fee reduction amount; selecting, by a processor of the processing server, a winning bid of the plurality of mining bids based on at least the fee reduction amount included in each of the plurality of mining bids; transmitting, by a transmitter of the processing server, a notification message to a winning blockchain node that submitted the winning bid; receiving, by the receiver of the processing server, a completed block including a block header and a plurality of data values, wherein the plurality of data values includes a mining data value that includes a destination address associated with the winning blockchain node and a mining fee amount; and verifying, by the processor of the processing server, the mining fee amount based on at least the fee reduction amount included in the selected winning bid.

A system for awarding blocks in a blockchain for mining based on fee reimbursement to encourage reduction in mining fees includes: a blockchain network including a plurality of blockchain nodes; and a processing server, the processing server including a receiver receiving a plurality of mining bids, where each mining bid is submitted by one of the plurality of blockchain nodes in the blockchain network and includes at least a fee reduction amount, a processor selecting a winning bid of the plurality of mining bids based on at least the fee reduction amount included in each of the plurality of mining bids, and a transmitter transmitting a notification message to a winning blockchain node that submitted the winning bid, wherein the receiver of the processing server further receives a completed block including a block header and a plurality of data values, wherein the plurality of data values includes a mining data value that includes a destination address associated with the winning blockchain node and a mining fee amount, and the processor of the processing server verifies the mining fee amount based on at least the fee reduction amount included in the selected winning bid.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for awarding blocks for mining in a blockchain with reduced mining fees in accordance with exemplary embodiments.

FIG. 2 is a block diagram illustrating the processing server of the system of FIG. 1 for encouraging fee reimbursement in a blockchain for reduced mining fees in accordance with exemplary embodiments.

FIG. 3 is a flow diagram illustrating a process for awarding a block in a blockchain with reduced mining fees based on a fee reimbursement bid in the system of FIG. 1 in accordance with exemplary embodiments.

FIG. 4 is a flow chart illustrating an exemplary method for awarding blocks in a blockchain for mining based on fee reimbursement to encourage reduction in mining fees in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Awarding Blocks Based on Fee Reimbursement

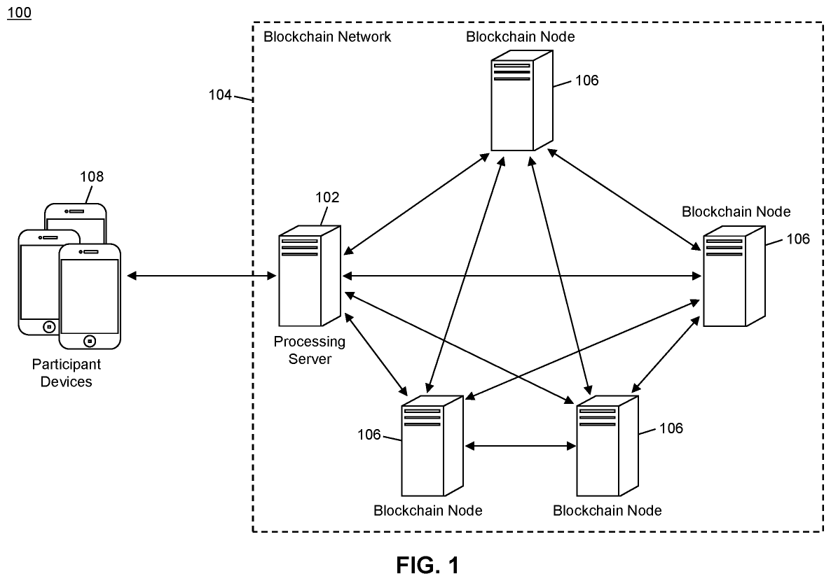

FIG. 1 illustrates a system 100 for awarding blocks for mining in a blockchain based on fee reimbursement via the collection of bids from blockchain nodes that promise reduction of mining fees.

The system 100 may include a processing server 102. The processing server 102, discussed in more detail below, may be configured to award blocks for mining for a blockchain associated with a blockchain network 104. The blockchain network 104 may be comprised of a plurality of blockchain nodes 106. In some cases, the processing server 102 may be a blockchain node 106 and/or configured to perform the functions associated therewith. For instance, the blockchain nodes 106 may agree to select one or more nodes to operate as processing servers 102 for the collection of bids and selection of winning bids, as discussed below. In an exemplary embodiment, the collection of bids and selection process may be automatic, and may utilize rules agreed on by each blockchain node 106 in the blockchain network, such as following the same consensus rules used for the blockchain.

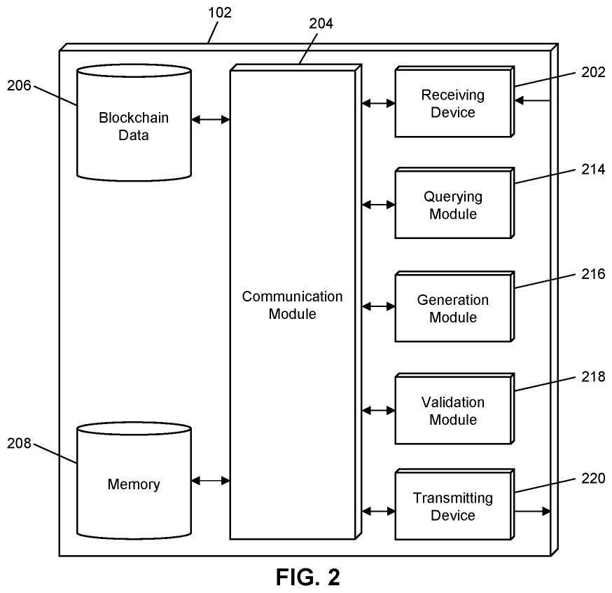

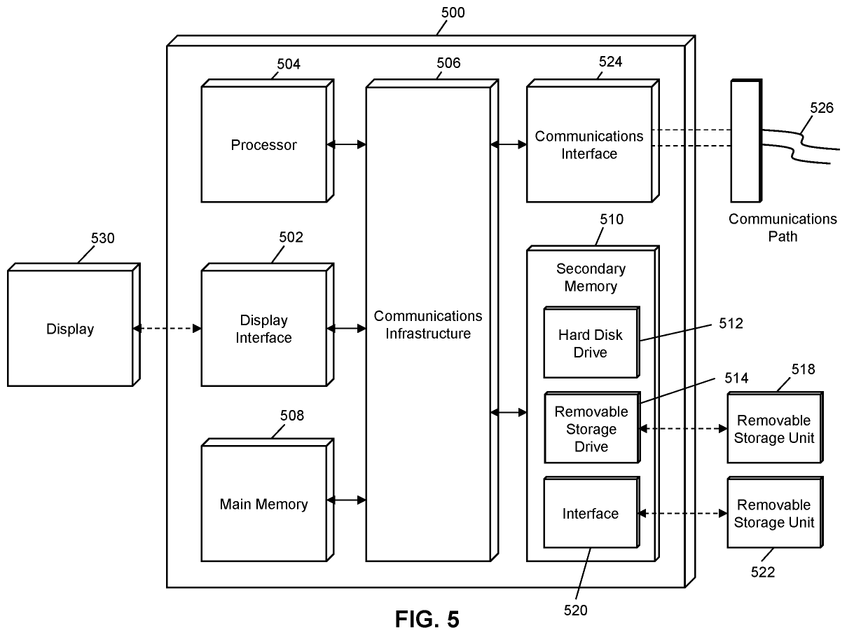

Each blockchain node 106 may be a computing system, such as illustrated in FIG. 2 and FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device (e.g., participant devices 108) that stores the private key for use thereof in blockchain transactions. For instance, each computing device may each have their own private key for respective cryptographic key pairs, and may each be a blockchain wallet for use in transactions with the blockchain associated with the blockchain network. Computing devices may be any type of device suitable to store and specifically programmed to utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of currency (e.g., a first participant device 108) that is generated using the sender's private key, a blockchain address of the recipient of currency (e.g., a second participant device 108) generated using the recipient's public key, and a blockchain currency amount that is transferred or other data being stored. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 106 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), and then include the blockchain transaction in a new block. The new block may be validated by other nodes in the blockchain network 104 before being added to the blockchain and distributed to all of the blockchain nodes 106 in the blockchain network 104 in traditional blockchain implementations. In cases where a blockchain data value may not be related to a blockchain transaction, but instead the storage of other types of data, blockchain data values may still include or otherwise involve the validation of a digital signature.

In traditional blockchain networks 104, the first blockchain node 106 to successfully create a block full of confirmed transactions, where the block itself can be validated (e.g., the block and data reference values successfully confirmed as accurate) by a majority of other blockchain nodes 106 may be considered as the winning miner for the block. As the winning miner, mining fees paid for the transactions in that block may be paid to the winning miner, via additional blockchain data values included in the block for payment from various senders to a blockchain wallet associated with the winning miner. For instance, a percentage (e.g., 1.5%) or a flat rate (e.g., 0.05 units of currency) of each transaction may be paid to the winning miner via blockchain data values included in the confirmed block, such as having the blockchain wallet associated with the winning miner as one of the recipients for every transaction to receive their mining fee.

In the system 100, blockchain nodes 106 may be required to submit bids to the processing server 102 to be able to be selected as the winning miner for a block. Each blockchain node 106 may submit a bid to the processing server 102 using any suitable communication network and method. For instance, in one embodiment, the processing server 102 may make a platform available for use by the blockchain nodes 106, such as via a web page, application program, application programming interface, etc. In another embodiment, the blockchain associated with the blockchain network 104 or an additional blockchain or sidechain may be used for the conveyance of bids, where a blockchain node 106 may submit their bid as a new blockchain data value in the blockchain. A mining bid may include at least an identifier associated with the blockchain node 106 that submitted the bid and a fee reduction amount. The identifier may be a unique value associated with the blockchain node 106 for use in identification thereof, such as an identification number, serial number, registration number, internet protocol address, media access control address, etc.

The fee reduction amount may be a percentage or amount that the blockchain node 106 is willing to reduce the fees by or may be an amount or percentage that the blockchain node 106 is willing to pay to mine transactions and/or a block, where representation thereof may vary based on the implementation of the system 100 and the blockchain associated with the blockchain network 104. For example, a mining bid may be a bid to accept only 50% of offered fees, a bid to reduce fees by 65%, a bid to accept only 0.7% of a transaction amount as a fee, a bid to reduce fees by 0.05 units of currency, a bid to accept only 0.1 units of currency as a fee for all transactions, etc. In some cases, the processing server 102 may be configured to select multiple types of mining bids. For instance, a first blockchain node 106 may submit a mining bid where they will reduce fees by 50%, while a second blockchain node 102 may submit a mining bid where they will accept only 0.1 units of currency for all transactions. In some embodiments, the blockchain network 104 may set a period of time during which mining bids may be submitted for consideration for an upcoming block. In such embodiments, bids may be collected immediately prior to a block's confirmation, or may be collected on a rolling basis for future blocks (e.g., collecting bids now for three blocks from now).

Once all of the mining bids have been collected for a block, the processing server 102 may select a winning bid. In some embodiments, the winning bid may be selected randomly from each of the plurality of mining bids collected for the block. In some instances, mining bids may be weighted based on their fee reduction amount. For example, if ten mining bids are collected where five mining bids have a fee reduction amount of reducing fees by 60% while the other five mining bids have a fee reduction amount of reducing fees by 40%, the five mining bids that have a fee reduction amount of 60% may have a higher likelihood of being selected as the winning bid. Such a weighting may encourage a higher reduction or lower overall fee to be paid. In one example, the processing server 102 may identify an average fee reduction amount of all collected mining bids, and may compare the fee reduction amount in each mining bid against the average to determine its weight. For instance, in the above example, each of the five mining bids that have a fee reduction amount of 60% may have a 12% chance to be selected while the five mining bids that have a fee reduction amount of 40% may have an 8% chance to be selected. In some instances, weighting may have upper and lower bounds. For instance, weighting may be such that no mining bid may have a greater than 20% chance to be selected or less than a 5% chance to be selected, such as to reduce the ability for a blockchain node 106 to have a fee reduction amount of 100% to guarantee a winning bid. In some cases, the average fee reduction amount used for weighting may be the mean. In other cases, the average fee reduction amount used for weighting may be the median of all fee reduction amounts. Other suitable calculations and determinations for weighting may be used by the processing server 102.

In some cases, mining bids may also be weighted based on history for each blockchain node 106 as selection as a winning bid. For instance, when a blockchain node 106 is selected as a winning miner, the blockchain node 106 may be heavily weighted against selection as the winning bid in the next block, where the weighting may become more favorable to the blockchain node 106 over time, such as reducing the weighting against in linear or exponential fashion. For example, in the above example, if one of the blockchain nodes 106 that has a mining bid with a fee reduction amount of 60% won the preceding bid process, that blockchain node 106 may have its weighting reduced to a 6% chance to be selected as the winning bid, which may steadily improve for each subsequent bid process until returning to the 12% chance (assuming the same mining bids are made by each blockchain node 106 and the blockchain node 106 is not selected again, and subject to other weightings based on selections of other blockchain nodes as winners).

The processing server 102 may select a winning bid of the plurality of mining bids submitted for a block. Once the winning bid is selected, the processing server 102 may notify the blockchain node 106 that submitted the winning bid using any suitable communication network and method. In some cases, the selected winning miner may be made public, such that each blockchain node 106 may be able to identify the winning blockchain node 106 and ensure their participation and reduction of fees as bid. For instance, if a separate blockchain or sidechain is used for bids, the winning bid may be indicated in a new entry in that chain. In another example, the processing server 102 may broadcast a message to the blockchain nodes 106 in the blockchain network 104 that identifies the winning blockchain node 106, which may be distributed similar to other messages and consensus operations in the blockchain network 104.

The winning blockchain node 106 may then generate and confirm the next (e.g., or other specified) block, where the mining fees collected therefrom are to be paid in accordance with their winning bid. The new block may be distributed to the other blockchain nodes 106 and confirmed using traditional methods and systems for confirmation of a new block in a blockchain. Once the new block is confirmed, it may be distributed to all of the blockchain nodes 106 in the blockchain network 104. In some embodiments, multiple blockchain nodes 106 may participate in generation of the new block where the winning blockchain node 106 may still be provided all mining fees associated therewith, such as to facilitate more efficient operation of the blockchain network 104. For example, each blockchain node 106 may still operate normally with respect to mining and confirming new blocks, but where mining fees are awarded based on the bidding process discussed herein. In some cases, some or all proof of work may be foregone in cases where bids are used to select a miner, such as to facilitate faster generation and confirmation of new blocks, provided that the data values and blocks themselves are still successfully confirmed. For instance, the identification of a nonce that results in a hash having sufficient leading zeroes, which may be performed as proof of work in many traditional blockchains to delay the addition of new blocks and force competition among miners may be skipped in the blockchain network 104.

The processing server 102 may be configured to review the blockchain data values in the new block to identify the mining fees collected by the winning blockchain node 106 that generated the block. The processing server 102 may analyze each of the blockchain data values to identify the mining fee collected by the winning blockchain node 106 and calculate the fee reduction amount based thereon. The processing server 102 can then verify if the wining blockchain node 106 reduced the mining fees paid in the confirmation of the new block by the fee reduction amount promised in the blockchain node's winning bid. If the mining fees were reduced properly, then the system 100 may continue to operate as normal and new bids collected and winning miners selected. In some cases, a winning bid may result in the winning blockchain node 106 mining the next predetermined number of blocks, where the winning blockchain node 106 may continue to do so as long as they are verified as reducing the fee amounts in accordance with their winning bid.

If the mining fees are not reduced properly by the winning blockchain node 106, the winning blockchain node 106 may be penalized by the processing server 102 and/or blockchain network 104. In some cases, the blockchain node 106 may be prohibited from mining any future blocks. In other cases, the blockchain node 106 may be ordered to return any fees in excess of the fee reduction amount in the winning bid (e.g., and additional fees as punishment) before being able to bid on any future blocks. In some instances, mining bids submitted by the blockchain node 106 may be weighted against in future selections as a result of their actions, which may heavily reduce the likelihood that the blockchain node 106 is selected as the winning miner. Such penalties may discourage a blockchain node 106 from straying from their winning bid, as they would be unable to nefariously collect enough mining fees from one block to make up for their inability to earn on future blocks. In some cases, any penalties levied on a blockchain node 106 may be broadcast to all other blockchain nodes 106 in the blockchain network 104, such as to help ensure that the penalized blockchain node 106 cannot have any new blocks generated thereby confirmed.

The methods and systems discussed herein enable blockchain nodes 106 to bid on new blocks to be mined in a blockchain network 104, where the bids include a fee reduction amount. Using a fee reduction amount to bid on mining of new blocks, especially in cases where selection of a winning bid is weighted based on the fee reduction amount in the respective bid, may encourage blockchain nodes 106 to collect less mining fees. This, in turn, results in participants paying less mining fees, enabling participants to keep more of their currency and still enjoy the benefits of the blockchain network 104. In instances where fee reduction amounts include flat rates of mining fees, there may be further benefits in that no submitted transactions can have higher fees paid than others, which may reduce instances where a transaction with a low mining fee has to wait a significant amount of time for confirmation, as each transaction would thereby be taken in turn of submission due to the fees paid therefor being the same. Thus, the methods and systems discussed herein result in more convenient processing of blockchain transactions for participants in addition to a reduction in fees paid thereby. Processing Server

FIG. 2 illustrates an embodiment of the processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102. The blockchain nodes 106 in the system 100 and illustrated in FIG. 1 may be implemented as the processing server 102 illustrated in FIG. 2 and discussed herein.

The processing server 102 may include a receiving device 202. The receiving device 202 may be configured to receive data over one or more networks via one or more network protocols. In some instances, the receiving device 202 may be configured to receive data from blockchain nodes 106, participant devices 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet.

The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by blockchain nodes 106 that are superimposed or otherwise encoded with mining bids, new blocks for confirmation, confirmed blocks, and other data used in the performance of the blockchain network 140. The receiving device 202 may also be configured to receive data signals electronically transmitted by participant devices, which may be superimposed or otherwise encoded with new blockchain data values for confirmation and inclusion in new blocks that are generated and added to the blockchain.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include a memory 208. The memory 208 may be configured to store data for use by the processing server 102 in performing the functions discussed herein, such as public and private keys, symmetric keys, etc. The memory 208 may be configured to store data using suitable data formatting methods and schema and may be any suitable type of memory, such as read-only memory, random access memory, etc. The memory 208 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art based on a reading of this disclosure. In some embodiments, the memory 208 may be comprised of or may otherwise include a relational database that utilizes structured query language for the storage, identification, modifying, updating, accessing, etc. of structured data sets stored therein. The memory 208 may be configured to store, for example, cryptographic keys, salts, nonces, communication information for blockchain nodes 106 and blockchain networks 104, address generation and validation algorithms, digital signature generation and validation algorithms, hashing algorithms for generating reference values, rules regarding generation of new blocks and block headers, a pool of pending transactions, mining bids, weighting algorithms and data, bid selection history, etc.

The processing server 102 may also include blockchain data 206, which may be stored in the memory 208 of the processing server 102 or stored in a separate area within the processing server 102 or accessible thereby. The blockchain data 206 may include a blockchain, which may be comprised of a plurality of blocks and be associated with the blockchain network 104. In some cases, the blockchain data 206 may further include any other data associated with the blockchain and management and performance thereof, such as block generation algorithms, digital signature generation and confirmation algorithms, communication data for blockchain nodes 106, collected mining bids, mining bid weighting and selection rules, etc.

The processing server 102 may include a querying module 214. The querying module 214 may be configured to execute queries on databases to identify information. The querying module 214 may receive one or more data values or query strings, and may execute a query string based thereon on an indicated database, such as the memory 208 of the processing server 102 to identify information stored therein. The querying module 214 may then output the identified information to an appropriate engine or module of the processing server 102 as necessary. The querying module 214 may, for example, execute a query on the memory 208 to identify weighting rules for application to collected mining bids and selection rules for selecting one of the collected mining bids as a winning bid for one or more future blocks to be confirmed in the blockchain.

The processing server 102 may also include a generation module 216. The generation module 216 may be configured to generate data for use by the processing server 102 in performing the functions discussed herein. The generation module 216 may receive instructions as input, may generate data based on the instructions, and may output the generated data to one or more modules of the processing server 102. For example, the generation module 216 may be configured to generate mining big weights, select a winning bid from a plurality of mining bids, generate blockchain data values, generate block and data reference values, generate block headers, generate blocks, etc.

The processing server 102 may also include a validation module 218. The validation module 218 may be configured to perform validations for the processing server 102 as part of the functions discussed herein. The validation module 218 may receive instructions as input, which may also include data to be used in performing a validation, may perform a validation as requested, and may output a result of the validation to another module or engine of the processing server 102. The validation module 218 may, for example, be configured to verify that a winning blockchain node 106 has complied with its winning mining bid by verifying that mining fees collected in a new block generated thereby comply with the fee reduction amount in their winning bid. The validation module 218 may also be configured to validate block reference values, data reference values, blockchain data values, new blocks, and other data in the performance of functions associated with the blockchain network 104.

The processing server 102 may also include a transmitting device 220. The transmitting device 220 may be configured to transmit data over one or more networks via one or more network protocols. In some instances, the transmitting device 220 may be configured to transmit data to blockchain nodes 106, participant devices 108, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to blockchain nodes 106 that are superimposed or otherwise encoded with winning bid notifications, blockchain data values, new blocks, confirmed blocks, notifications regarding compliance penalties, bid acceptance dates, etc. The transmitting device 220 may also be configured to electronically transmit data signals to participant devices 108, which may be superimposed or otherwise encoded with notifications regarding mining bids, such as information on winning mining bids (e.g., fee reduction amounts for use by participant devices 108 in selecting future payment amounts to accommodate fee reductions), information on confirmed or unconfirmed transactions, and other data and notifications as part of the functions of the processing server 102 as discussed herein and as a blockchain node 106 in the blockchain network 104.

### Process for Awarding Blocks in a Blockchain

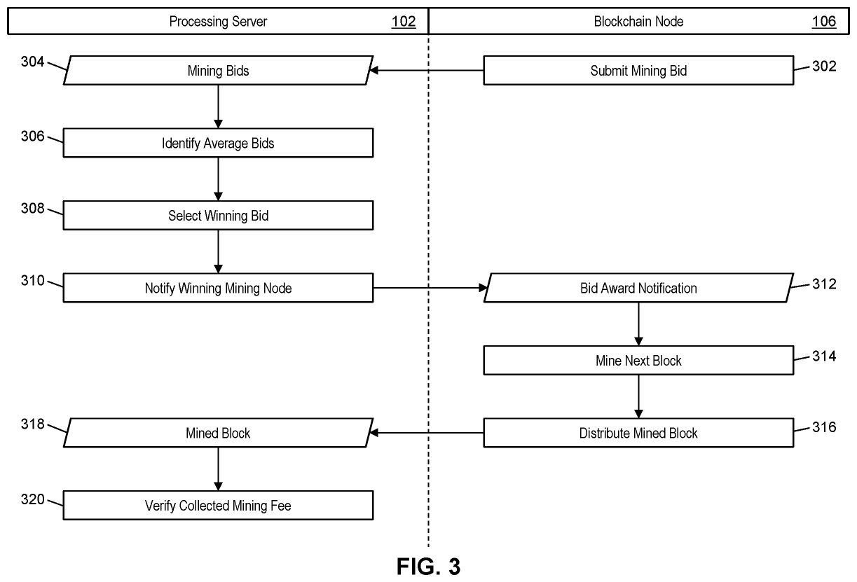

FIG. 3 illustrates a process for awarding blocks in a blockchain to a blockchain node 106 in the system 100 of FIG. 1 based on selection of the blockchain node 106 as a winning miner based on an associated mining bid in a plurality of mining bids collected to reduce mining fees paid in the blockchain network 104.

In step 302, a plurality of blockchain nodes 106 in the blockchain network 104 may submit a mining bid to the processing server 102 using a suitable communication network and method, such as via an application programming interface of the processing server 102 or a blockchain (e.g., the same blockchain for which the blockchain nodes 106 are bidding for mining fees, or a separate blockchain). In latter instances, each mining bid may be digitally signed by the submitting blockchain node 106 using a private key of a cryptographic key pair associated therewith, such as the same cryptographic key pair comprising the blockchain node's blockchain wallet that may be used to collect mining fees. In step 304, the receiving device 202 of the processing server 102 may receive the mining bids, where each mining bid may include at least an identifier associated with the submitting blockchain node 106 and a fee reduction amount. The processing server 102 may continue to receive mining bids from blockchain nodes 106 during a specified bid acceptance period.

In step 306, once any applicable bid acceptance period has completed, the processing server 102 may determine an average fee reduction amount from each of the mining bids collected from blockchain nodes 106. In step 308, the generation module 216 of the processing server 102 may select a winning bid from the plurality of mining bids collected in step 304. In some embodiments, each of the mining bids may be weighted based on its own fee reduction amount as compared to the average fee reduction amount identified in step 306. In some cases, weights may be further adjusted based on any penalties levied on or recent selection history of the associated blockchain node 106. In cases where mining bids may be weighted, the selection of a winning bid may utilize the weighting such that weighting may give a mining bid a greater or lesser chance of being selected as compared to other mining bids. In instances where weighting is not used, each mining bid may have an equal chance at being selected as the winning bid. Once the winning bid has been selected, then, in step 310, the transmitting device 220 of the processing server 102 may electronically transmit a notification to the blockchain node 106 that submitted the winning bid. In some cases, notifications may also be transmitted to other blockchain nodes 106, such as to inform each node that it was not selected, and/or to inform each node of the winning blockchain node 106.

In step 312, the winning blockchain node 106 may receive the notification that it was selected as the winning bid and awarded the mining fees for the next block (e.g., or other specified block or blocks). In step 314, the winning blockchain node 106 my mine the next block by confirming pending blockchain transactions and including them as the blockchain data values in a new block that is generated by the blockchain node 106 that includes a block header including a block reference value referring to the header of the preceding block I the blockchain and a data reference value that refers to the blockchain data values confirmed for the new block. The data reference values may also include the payment of mining fees to a blockchain wallet associated with the winning blockchain node 106. In step 316, the winning blockchain node 106 may distribute the mined block to other blockchain nodes 106 in the blockchain network 104 for confirmation thereof, which may further result in the block being distributed to all blockchain nodes 106 in the blockchain network 104. As part of the distribution of the newly mined block, the block may be transmitted to or otherwise accessed by the processing server 102.

In step 318, the receiving device 202 of the processing server 102 may receive the newly mined block. In step 320, the validation module 218 of the processing server 102 may verify that the mining fees collected by the winning blockchain node 106 in the newly mined block are in accordance with the winning mining bid submitted by the winning blockchain node 106 and selected by the processing serve 102. If the winning blockchain node 106 successfully complied with their bid, then the process may be complete and continue for future bids on future blocks. If the winning blockchain node 106 did not comply with their bid (e.g., they took fees above their promised fee reduction amount), then the processing server 102 or blockchain network 104 may assess penalties on the winning blockchain node 106, such as discussed above.

### Exemplary Method for Awarding Blocks in a Blockchain for Mining

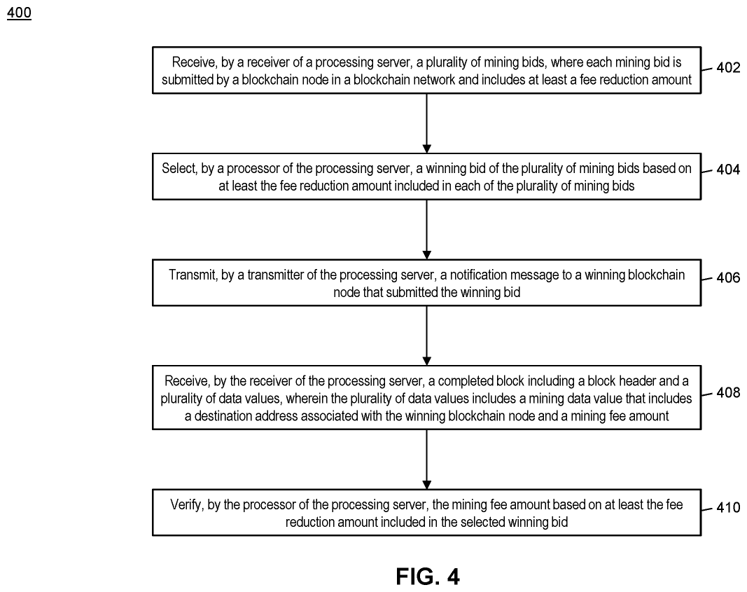

FIG. 4 illustrates a method 400 for awarding blocks in a blockchain for mining based on fee reimbursement to encourage reduction in mining fees.

In step 402, a plurality of mining bids may be received by a receiver (e.g., the receiving device 202) of a processing server (e.g., the processing server 102), where each mining bid is submitted by a blockchain node (e.g., blockchain node 106) in a blockchain network (e.g., the blockchain network 104) and includes at least a fee reduction amount. In step 404, a winning bid of the plurality of mining bids may be selected by a processor (e.g., the generation module 216) of the processing server based on at least the fee reduction amount included in each of the plurality of mining bids.

In step 406, a notification message may be transmitted by a transmitter (e.g., the transmitting device 220) of the processing server to a winning blockchain node that submitted the winning bid. In step 408, a completed block including a block header and a plurality of data values may be received by the receiver of the processing server, wherein the plurality of data values includes a mining data value that includes a destination address associated with the winning blockchain node and a mining fee amount. In step 410, the mining fee amount may be verified by the processor (e.g., validation module 218) of the processing server based on at least the fee reduction amount included in the selected winning bid.

In one embodiment, verification of the mining fee amount may be further based on a total transaction amount for the completed block based on a transaction amount included in each of the plurality of data values not including the mining data value. In some embodiments, the method 400 may further include repeating, by the processing server, receipt of a completed block and verification of the mining fee amount in the completed block for a predetermined number of additional blocks mined by the winning blockchain node. In one embodiment, the plurality of mining bids may be stored in a blockchain associated with the blockchain network, and each mining bid may be digitally signed using a private key of a cryptographic key pair associated with the submitting blockchain node. In some embodiments, the winning bid may be selected randomly from the plurality of mining bids.

In one embodiment, each of the plurality of mining bids may be weighted for selection as the winning bid, where the weighting is based on the fee reduction amount included in the respective mining bid. In a further embodiment, the weighting may be further based on a proportion of the fee reduction amount included in the respective mining bid against an average reduction amount based on the fee reduction amount included in each of the plurality of mining bids. In another further embodiment, the weighting may have an upper bound and a lower bound for the fee reduction amount.

### Computer System Architecture

FIG. 5 illustrates a computer system 500 in which embodiments of the present disclosure, or portions thereof, may be implemented as computer-readable code. For example, the processing server 102 and blockchain nodes 106 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to act as a special purpose computer to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for awarding blocks in a blockchain for mining based on fee reimbursement to encourage reduction in mining fees. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for awarding blocks in a blockchain for mining based on fee reimbursement to encourage reduction in mining fees, comprising:
receiving, by a receiver of a processing server, a plurality of mining bids, where each mining bid is submitted by a blockchain node in a blockchain network and includes at least a fee reduction amount;
selecting, by a processor of the processing server, a winning bid of the plurality of mining bids based on at least the fee reduction amount included in each of the plurality of mining bids;
transmitting, by a transmitter of the processing server, a notification message to a winning blockchain node that submitted the winning bid;
receiving, by the receiver of the processing server, a completed block including a block header and a plurality of data values, wherein the plurality of data values includes a mining data value that includes a destination address associated with the winning blockchain node and a mining fee amount; and
verifying, by the processor of the processing server, the mining fee amount based on at least the fee reduction amount included in the selected winning bid.

2. The method of claim 1, wherein verification of the mining fee amount is further based on a total transaction amount for the completed block based on a transaction amount included in each of the plurality of data values not including the mining data value.

3. The method of claim 1, further comprising:
repeating, by the processing server, receipt of a completed block and verification of the mining fee amount in the completed block for a predetermined number of additional blocks mined by the winning blockchain node.

4. The method of claim 1, wherein
the plurality of mining bids are stored in a blockchain associated with the blockchain network, and
each mining bid is digitally signed using a private key of a cryptographic key pair associated with the submitting blockchain node.

5. The method of claim 1, wherein the winning bid is selected randomly from the plurality of mining bids.

6. The method of claim 1, wherein each of the plurality of mining bids is weighted for selection as the winning bid, where the weighting is based on the fee reduction amount included in the respective mining bid.

7. The method of claim 6, wherein the weighting is further based on a proportion of the fee reduction amount included in the respective mining bid against an average reduction amount based on the fee reduction amount included in each of the plurality of mining bids.

8. The method of claim 6, wherein the weighting has an upper bound and a lower bound for the fee reduction amount.

9. A system for awarding blocks in a blockchain for mining based on fee reimbursement to encourage reduction in mining fees, comprising:
a blockchain network including a plurality of blockchain nodes; and
a processing server, the processing server including
a receiver receiving a plurality of mining bids, where each mining bid is submitted by one of the plurality of blockchain nodes in the blockchain network and includes at least a fee reduction amount,
a processor selecting a winning bid of the plurality of mining bids based on at least the fee reduction amount included in each of the plurality of mining bids, and
a transmitter transmitting a notification message to a winning blockchain node that submitted the winning bid, wherein
the receiver of the processing server further receives a completed block including a block header and a plurality of data values, wherein the plurality of data values includes a mining data value that includes a destination address associated with the winning blockchain node and a mining fee amount, and
the processor of the processing server verifies the mining fee amount based on at least the fee reduction amount included in the selected winning bid.

10. The system of claim 9, wherein verification of the mining fee amount is further based on a total transaction amount for the completed block based on a transaction amount included in each of the plurality of data values not including the mining data value.

11. The system of claim 9 wherein the processing server repeats receipt of a completed block and verification of the mining fee amount in the completed block for a predetermined number of additional blocks mined by the winning blockchain node.

12. The system of claim 9, wherein
the plurality of mining bids are stored in a blockchain associated with the blockchain network, and
each mining bid is digitally signed using a private key of a cryptographic key pair associated with the submitting blockchain node.

13. The system of claim 9, wherein the winning bid is selected randomly from the plurality of mining bids.

14. The system of claim 9, wherein each of the plurality of mining bids is weighted for selection as the winning bid, where the weighting is based on the fee reduction amount included in the respective mining bid.

15. The system of claim 14, wherein the weighting is further based on a proportion of the fee reduction amount included in the respective mining bid against an average reduction amount based on the fee reduction amount included in each of the plurality of mining bids.

16. The system of claim 14, wherein the weighting has an upper bound and a lower bound for the fee reduction amount.
